(19) United States
(12) Patent Application Publication
(10) Pub. No.: US 2008/0073806 A1
(43) Pub. Date: Mar. 27, 2008

(54) Method for foaming multiple color sole

(76) Inventor: Ming-Hui Wang, Taichung City (TW)

Correspondence Address: Ming-Hui Wang, 235 Chung-Ho Box 8-24, Taichung City, omitted

(21) Appl. No.: 11/527,164

(22) Filed: Sep. 27, 2006

(51) Int. Cl. B29C 44/04

(52) U.S. Cl. 264/45.1

(57) ABSTRACT

A method for foaming a multiple color sole comprises the steps of: placing a spacer between a male mold and a female mold; wherein the spacer has at least two flow channels; the spacers having flow channels communicated to the male mold and female mold; filling pigments into inlets of the two flow channels of the spacer by using material filling machines to the predetermined positions of the male mold and female mold; wherein the foaming materials are installed in the male mold and female mold in advance; opening the male mold and female mold and taking out the spacer; closing the male mold and female mold and then foaming the foaming material in the male mold and female mold; and opening the male mold and female mold; the foamed two color sole being taken out.

### FIELD OF THE INVENTION CD

The present invention relates to soles of shoes, and particularly to a method for foaming a multiple color sole, wherein the pigments in the boundaries of the two layers are not mixed to each other, and the processes for foaming different layers of different colors can be formed at the same time.

### BACKGROUND OF THE INVENTION

The processes for foaming the prior art colored soles has the steps of foaming single color and single layer sole by injection molding; then the sole being placed into another mold for foaming another layer of different color so as to foaming a sole with different colors. Then the mold is opened.

However, the prior art has the disadvantages that the two layers of sole are injected out by different injection molding steps. The pigments at the boundaries of the two layers will be mixed to each other so as to form an ugly outlook. Thus, the quality of the sole is reduced.

### SUMMARY OF THE INVENTION

Accordingly, the primary object of the present invention is to provide a method for foaming a multiple color sole, wherein the pigments in the boundaries of the two layers are not mixed to each other, and the processes for foaming different layers of different colors can be formed at the same time. To achieve above objects, the present invention provides a method for foaming a multiple color sole which comprises the steps of: placing a spacer between a male mold and a female mold; wherein the spacer has at least two flow channels; the spacers having flow channels communicated to the male mold and female mold; filling pigments into inlets of the two flow channels of the spacer by using material filling machines to the predetermined positions of the male mold and female mold; wherein the foaming materials are installed in the male mold and female mold in advance; opening the male mold and female mold and taking out the spacer; closing the male mold and female mold and then foaming the foaming material in the male mold and female mold; and opening the mold: opening the male mold and female mold; the foamed two color sole being taken out.

The various objects and advantages of the present invention will be more readily understood from the following detailed description when read in conjunction with the appended drawing.

### BRIEF DESCRIPTION OF THE DRAWINGS

FIG. 1 is a flow diagram of the multiple color sole of the present invention.

FIG. 2 is a perspective view of the multiple color sole of the present invention.

FIGS. 3A to 3D are schematic views showing the process of the multiple color sole of the present invention.

FIG. 4 shows the second embodiment of the present invention, wherein a rotary disk is used to receive pigments from a pigment injection machine.

FIGS. 5A to 5D are schematic views showing the foaming process in the second embodiment of the present invention.

FIG. 6 is a perspective view about the two color sole of the second embodiment of the present invention.

FIG. 7 is a schematic cross sectional view about the third embodiment of the present invention, wherein a spacer is placed connected two half molds.

FIG. 8 is a lateral schematic view about the sole of the third embodiment of the present invention, wherein the shoe toe and heel of the sole are separated.

### DETAILED DESCRIPTION OF THE INVENTION

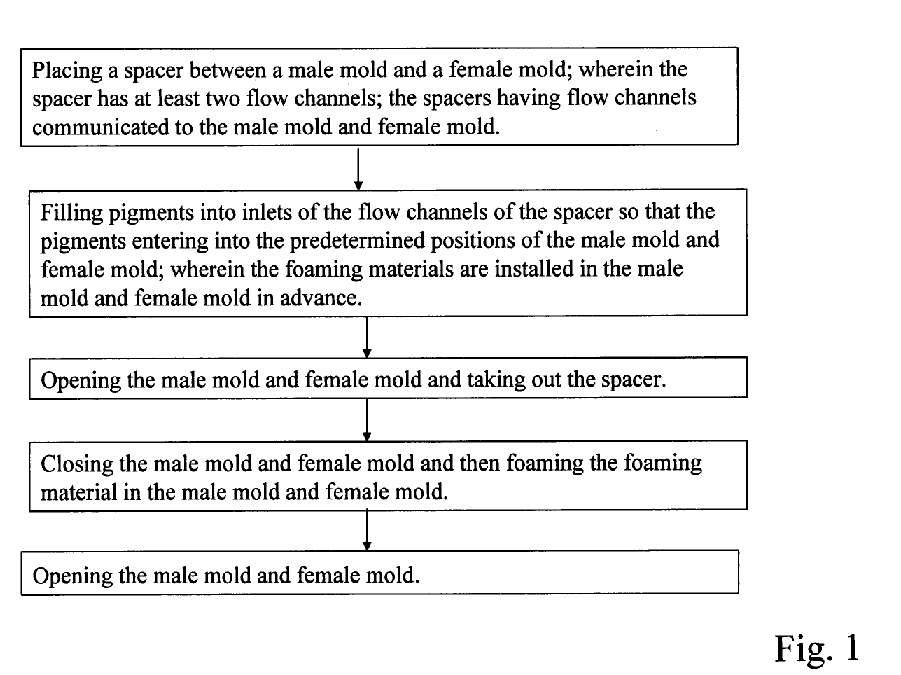

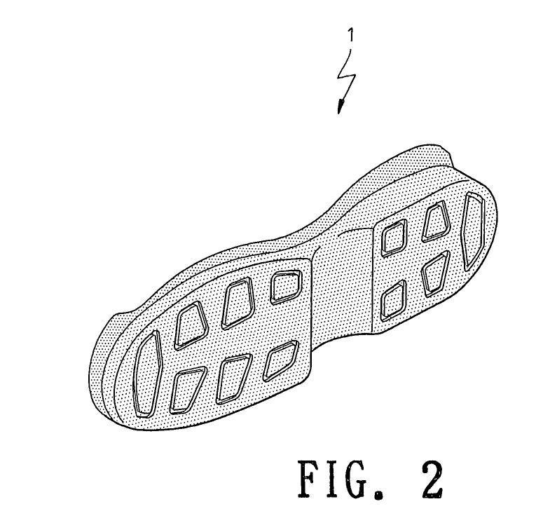

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. With referring to FIGS. 1, 2 3A to 3D, the present invention include the following steps of:

Placing a spacer: placing a spacer 30 between a male mold 10 and a female mold 20; wherein the spacer 30 has at least two flow channels 31 (the number of the flow channels is increased according to the injection mi position and number of colors). Openings 32 of the flow channels 31 face to the male mold 10 and female mold 20, respectively.

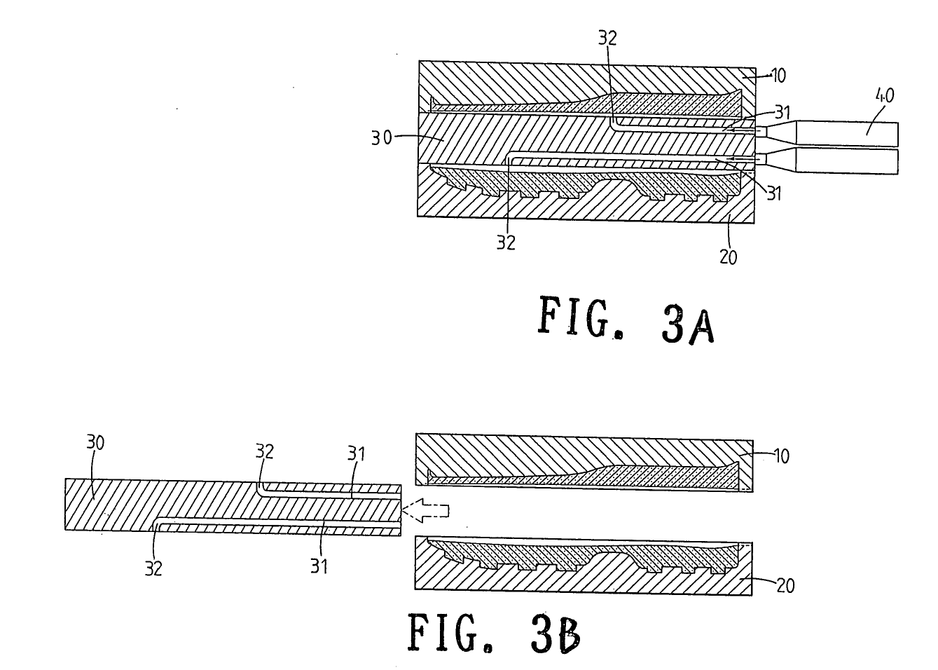

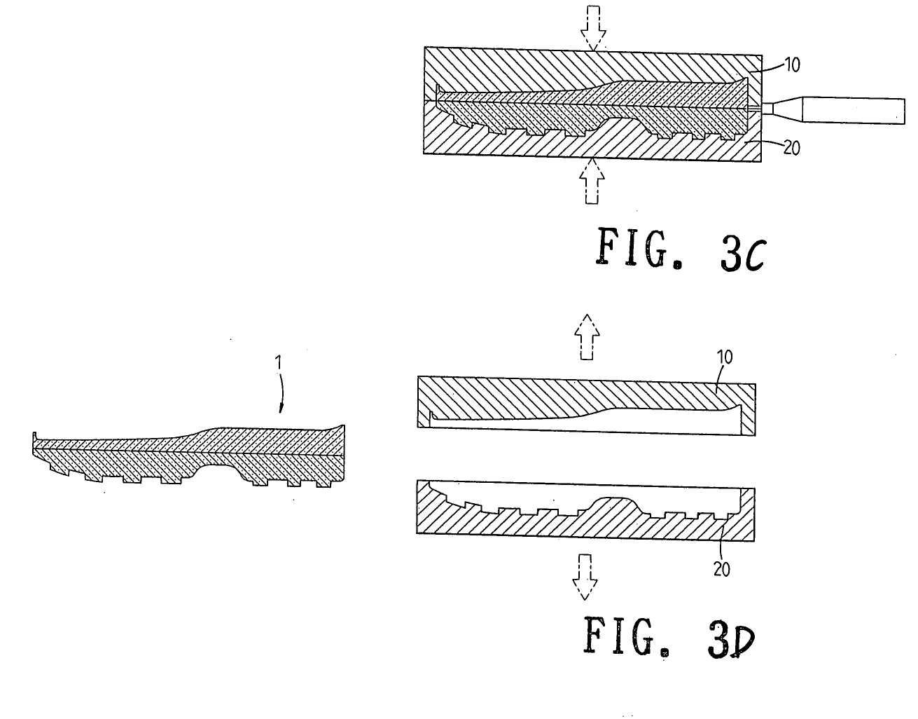

Injection material: by using material filling machines 40, filling pigments into inlets of the two flow channels 31 of the spacer 30 to the predetermined positions of the male mold 10 and female mold 20; wherein the foaming materials are installed in the male mold 10 and female mold 20 in advance (referring to FIG. 3A);

Taking out the spacer: opening the male mold 10 and female mold 20 and taking out the spacer 30 (referring to FIG. 3B);

Foaming: closing the male mold 10 and female mold 20 and then foaming the sole in the mold (referring to FIG. 3C).

Opening the mold: opening the male mold 10 and female mold 20; the foamed two color sole I being taken out (referring to FIG. 3D).

By above five steps, a two color (or more color) sole is formed by one injection operation. However, in the prior art, two color un-foamed clamp layers are injected and then the layers are placed in the molds, while in the present invention, this process is not used.

In the present invention, the pigments of two colors of the sole are filling into the male mold 10 and female mold 20 at the same time. Then they are foamed and shaped so as to overcome the problem of mixing of pigments in the prior art. Thus, no trace is formed between the two colors in the sole.

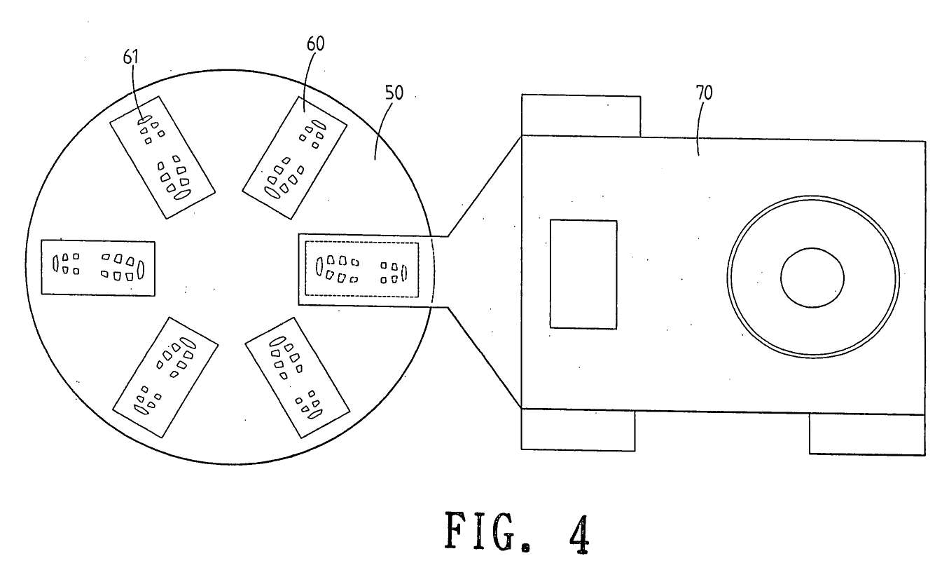

Referring to FIG. 4, in this embodiment, the bottom sole has a plurality of colored sections. A rotary disk 50 is installed with a plurality of pre-shaped spacers 60. When the rotary disk 50 rotates to an injection machine 70, the pigments in the injection machine 70 are filled into the pre-shaped spacer 60 so as to form the pigment sections 61.

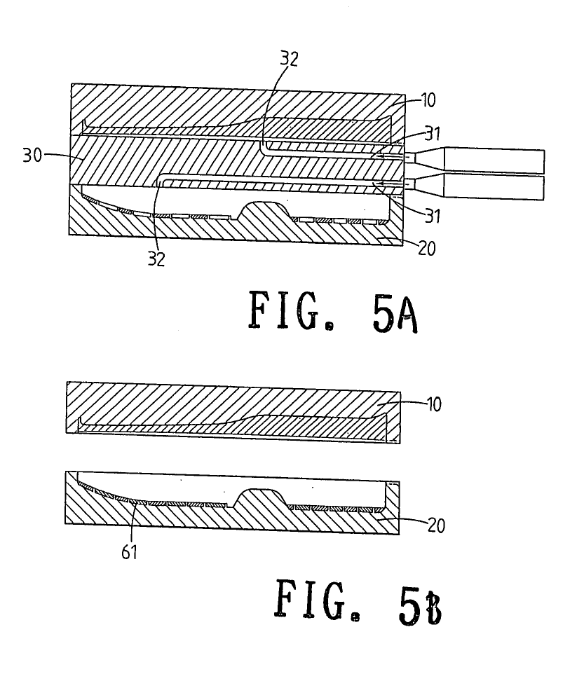

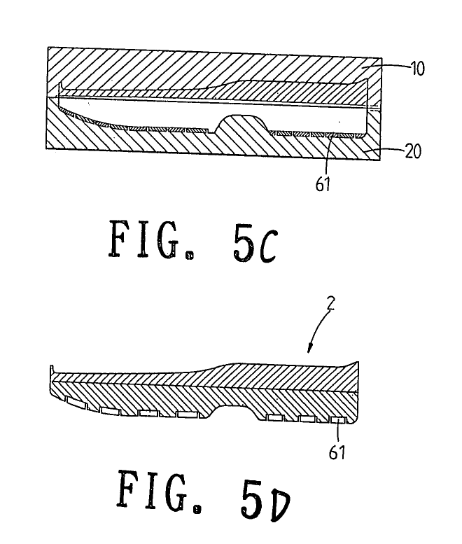

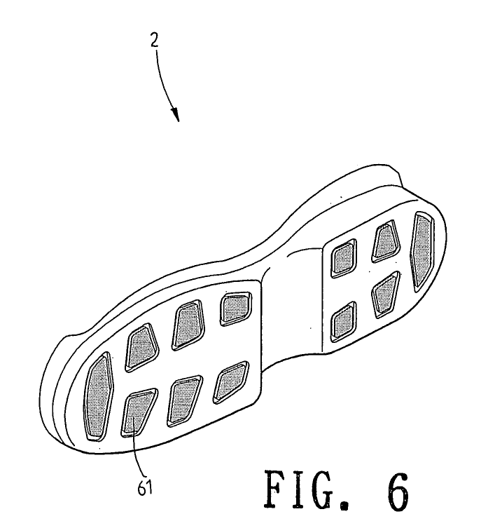

Referring to FIG. 5A, a spacer 30 is placed between the male mold 10 and female mold 20. Pigments are injected into the male mold 10 and female mold 20 through the flow channels 31, 32. Then the spacer 30 is taken out. Referring to FIG. 5B, then the pigment sections 61 are placed in the predetermined areas in the female mold 20. Referring to FIG. 5C, the male mold 10 and female mold 20 are combined and then the foaming materials in the male mold 10 and female mold 20 are formed with the pigments. After foaming, the two color sole is taken out, as shown in FIG. 5D.

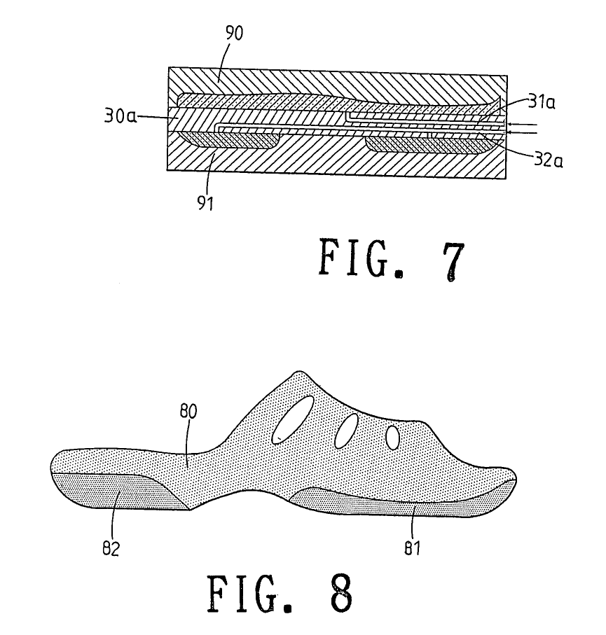

Referring to FIGS. 7 and 8, the third embodiment of the present invention is illustrated. In this embodiment, the upper layer and lower layer of the sole have different colors. Thereby in the lower layer, the shoe toe 82 and heel 81 have different colors from the sole 80. In the manufacturing process, a spacer 30a is placed between the upper mold and lower mold. The spacer 30a has an upper flow channel 31a and a lower flow channel 32a. The upper flow channel 31a is communicated to the upper mold 90 and the lower flow channel 32a is communicated to the lower mold 91. The lower flow channel 32a has two paths communicated to the lower mold 91. In pigment injection, one pigment is injected into the upper mold 90 and another pigment is injected into the toe and heel sections of the lower mold 91. Then the processing of removing the spacer, foaming and opening molds are performed so as to form a sole as illustrated in FIG. 8. In that the shoe toe 82, heel 81 and the sole 80 have different colors.

However, the flow channels and spacers are not confined by above mentioned structure. Other ways are permissible in the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for foaming a multiple color sole comprising the steps of:
placing a spacer between a male mold and a female mold; wherein the spacer has at least two flow channels; the spacers having flow channels communicated to the male mold and female mold;
filling pigments into inlets of the flow channels of the spacer so that the pigments entering into the predetermined positions of the male mold and female mold; wherein the foaming materials are installed in the male mold and female mold in advance;
opening the male mold and female mold and taking out the spacer;
closing the male mold and female mold and then foaming the foaming material in the male mold and female mold; and
opening the male mold and female mold; the foamed multiple color sole being taken out.

2. The method of claim 1, wherein the number of the pigment injection machine is identical to the number of the flow channels in the spacer.

3. The method of claim 1, wherein there are two flow channels communicated to one of the male mold and female mold and one flow channel communicated to the other one of the male mold and female mold.
